(19) United States
(12) Patent Application Publication
(10) Pub. No.: US 2013/0167723 A1
(43) Pub. Date: Jul. 4, 2013

(54) METHOD FOR MODIFYING POROUS SUBSTRATE AND MODIFIED POROUS SUBSTRATE

(71) Applicant: INDUSTRIAL TECHNOLOGY RESEARCH INSTITUTE, Hsinchu (TW)

(72) Inventors: Meng-Chang LIN, Taichung City (TW); Yu-Li LIN, Chiayi City (TW); Yen-Hsun CHI, Taitung City (TW); Jun-Yen UAN, Tainan City (TW)

(73) Assignee: INDUSTRIAL TECHNOLOGY RESEARCH INSTITUTE, Hsinchu (TW)

(21) Appl. No.: 13/727,496

(22) Filed: Dec. 26, 2012

Related U.S. Application Data
(63) Continuation-in-part of application No. 13/557,763, filed on Jul. 25, 2012.

(30) Foreign Application Priority Data
Dec. 30, 2011 (TW) 100149772
Oct. 31, 2012 (TW) 101140246

(51) Int. Cl. B01D 71/02

(52) U.S. Cl. CPC B01D 71/024
USPC 96/11; 428/312.8; 427/243; 427/181

(57) ABSTRACT

A method for modifying a porous substrate, including: coating at least a metal hydroxide layer on a porous substrate; and calcining the porous substrate with the metal hydroxide layer coated thereon to transform the metal hydroxide layer into a continuous metal oxide layer, forming a modified porous substrate. The disclosure also provides a modified porous substrate.

### CROSS REFERENCE TO RELATED APPLICATIONS

This application is a Continuation-In-Part of pending U.S. patent application Ser. No. 13/557,763, filed Jul. 25, 2012 and entitled “METHOD FOR MODIFYING POROUS SUBSTRATE AND MODIFIED POROUS SUBSTRATE ”, which claims priority of Taiwan Patent Application No. 100149772, filed on Dec. 30, 2011, the entirety of which is incorporated by reference herein.

This application claims priority of Taiwan Patent Application No. 101140246, filed on Oct. 31, 2012, the entirety of which is incorporated by reference herein.

### BACKGROUND

1. Technical Field

The present disclosure relates to a method for modifying a porous substrate and a modified porous substrate.

2. Description of the Related Art

Hydrogen energy is less harmful to the environment and can be continuously recycled and reused, and it is a new energy source with bright prospects. Steam reforming is the major process for generating hydrogen. However, since steam reforming is highly endothermic, an extremely high temperature is required to obtain sufficient conversion rates for thermodynics reasons. When the reaction pressure is 1000 kPa and the ratio of water to methane is 3, a reaction temperature of 850° C. is required for a methane conversion rate of 90%. For steam reforming, if 90% of the hydrogen gas can be removed in time, then the reaction temperature required may only be 500° C. A layer of palladium or Pd—Ag alloys, Pd—Cu alloys, vanadium alloys, niobium alloys, tantalum alloys may be used to separate and purify hydrogen gas. By incorporating a layer of palladium or its alloy in the steam reforming reactor, the selective hydrogen permeation mechanism of palladium or its alloy with its selective hydrogen permeation characteristics may shift thermodynamic equilibrium by selectively separating hydrogen from syngas in the steam reforming reactor, thus enhancing the hydrogen conversion rate. The mechanism of hydrogen permeation of palladium involves the adsorption of hydrogen gas onto the surface of palladium with a higher hydrogen gas concentration (reaction side), the dissociation of adsorbed hydrogen gas into hydrogen atoms, and subsequent dissolution of the hydrogen atoms into the interior of the palladium and then diffusion to another end where the hydrogen gas concentration is lower (permeation side). The hydrogen atoms diffused to the surface at the end with a lower hydrogen gas concentration are then re-bonded to become hydrogen molecules, which are desorbed from the surface. The flux of hydrogen gas may be described with the formula:

$$J = \frac{{Q}_{0}}{L} exp ( - \frac{E}{RT} ) ( {P}_{{H}_{2} , h}^{n} - {P}_{{H}_{2} , 1}^{n} ) ,$$

wherein Q₀ is the permeability constant, L is the thickness of the Pd layer, and E is the activation energy for permeation. Other than being influenced by temperature and pressure, the flux of hydrogen gas is even more influenced by the Pd layer, the thickness of which is inversely proportional to the flux of hydrogen gas. The thinner the Pd layer, the higher the hydrogen gas flux and the lower the costs. However, the Pd layer has some problems to be solved, for example, it cannot withstand the reaction environment with high temperature and the high pressure.

Therefore, it is necessary to develop a method for fabricating a suitable modifying layer on a porous substrate.

### SUMMARY

One embodiment of the disclosure relates to a method for modifying a porous substrate, comprising: coating at least a metal hydroxide layer on a porous substrate; and calcining the porous substrate having the metal hydroxide layer to transform the metal hydroxide layer into a continuous metal oxide layer, forming a modified porous substrate.

One embodiment of the disclosure also relates to a modified porous substrate, comprising: a porous substrate; and a continuous metal oxide layer, coated on the porous substrate, wherein the continuous metal oxide layer is a first metal oxide containing a first metal and a second metal that is different from the first metal.

A detailed description is given in the following embodiments with reference to the accompanying drawings.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. When one layer is described to be on or above another layer (or substrate), the layer may be in direct contact with another layer (substrate), or there may be an intervening layer between the two layers.

One embodiment of the disclosure is related to a method for modifying porous substrate and a modified porous substrate, wherein a metal hydroxide layer is first formed on the porous substrate, and the metal hydroxide layer is then calcined to be transformed into a continuous metal oxide layer, thereby completing the modification of the porous substrate. The details of the embodiments of the disclosure will be described and discussed below.

First, a porous substrate, such as a porous metal substrate, is provided. The porous metal substrate may comprise stainless steels or nickel-based alloys. The pore diameter of the porous substrate may be about 1-30 μm. In preferred embodiments, the porous metal substrate may comprise porous stainless steels such as stainless steel 301, 304, 321, 316, 304L, 316L, 410, 416, 420, or 430, or nickel-based alloys such as Hastelloy C-276, C-22, X, N, B and B2, Inconel 600, 625 and 690, Nickel 200 or Monel® 400 (70 Ni-30 Cu).

Then, a metal hydroxide layer is coated on the porous substrate. It is to be noted that the metal hydroxide layer is preferably made of a material that has a coefficient thermal expansion (CTE) and/or crystal lattice close to that of the porous substrate (the largest CTE difference may reach 1.2×10⁻⁵ K⁻¹) to achieve enhanced structural stability, for example, enhanced adhesion and so on, so that there is good material compatibility between the metal oxide layer obtained after calcination (i.e. the modifying layer) and the porous substrate. The metal hydroxide layer may comprise magnesium hydroxide, aluminum hydroxide, chromium hydroxide, lithium hydroxide, sodium hydroxide, potassium hydroxide, zinc hydroxide, iron hydroxide, nickel hydroxide, manganese hydroxide, calcium hydroxide, copper hydroxide, or combinations thereof. The metal hydroxide layer may have a thickness of about 0.1-5 μm. However, the thickness may be adjusted based on need and on the principle of not overly blocking the pores of the porous substrate. The coating of the metal hydroxide layer may be by a method such as an electrochemical electroplating, hot dip plating, physical vapor deposition, chemical vapor deposition, co-precipitation, hydrothermal method, or other suitable methods. In some embodiments, co-precipitation may be used, for example, the co-precipitation method proposed by Sissoko et al. (I. Sissoko, E. T. Iyagba, R. Sahai, P. Biloen, J. Solid State Chem., 1985, 60, 283-288), which is herein incorporated in its entirety by reference. In the co-precipitation method, a mixture of a plurality of metal salts, for example a mixture of sodium salt, aluminum salt, and carbonate salt, is dissolved in a high concentration basic solution. The high concentration basic solution with metal salts added is then heated at a temperature of about 60-90° C. and continuously stirred for about 12-18 hours to form the metal hydroxide layer. In the embodiments, the method for fabricating “layered double hydroxide (LDH)” proposed by Hsieh et al. may be used, which is herein incorporated in its entirety by reference, to form the metal hydroxide layer of the present disclosure. Basically, the substrate is immersed in a basic solution containing two different metal cations (M_{A}^{z+} and M_{B}³⁺, z=1 or 2) to form highly oriented layered double oxide (i.e. the metal hydroxide layer), wherein M_{B} is the major metal element and M_{A} is the secondary metal element of the metal hydroxide layer, and wherein the method for preparing the basic solution containing two different metal cations comprises the step of placing the intermetallic compound (M_{A}M_{B}) powder into pure water under an ambient environment, and then gas (Ar or N₂) exposure and stirring processes are performed, such that most of the intermetallic compound (M_{A}M_{B}) powder is dissolved by reacting with water, thereby obtaining the basic solution containing M_{A} and M_{B} cations. Furthermore, the thickness of the metal hydroxide layer may be controlled by controlling the growth time and the number of times of immersion. For example, the longer the immersion time and the higher the number of times of immersion, the larger the thickness of the metal hydroxide layer may be obtained. The layered double hydroxide can be described with the following formula:

[M_{A}_{_{1-X}}_{^{z+}}M_{B}_{_{X}}_{³⁺}(OH)₂]^{A+}[X^{m-}]A/m·mH₂O

In some embodiments, X may be about 0.67-0.80. M_{B}³⁺ may comprise for example Al³⁺, Mn³⁺, Ni³⁺, Fe³⁺, or Cr³⁺. M_{A}^{z+} may comprise for example Ni²⁺, Mg²⁺, Zn²⁺, Ca²⁺, Cu²⁺, Mn²⁺, Li⁺, Na⁺, or K⁺. X^{m-} may comprise for example CO₃²⁻, NO₃⁻, Cl⁻, SO₄⁻, OH⁻, PO₄⁻, or I⁻.

In another embodiment, a plurality of particles such as aluminum oxide, silicon oxide, calcium oxide, cerium oxide, titanium oxide, chromium oxide, manganese oxide, iron oxide, nickel oxide, copper oxide, zinc oxide and zirconium oxide, is filled into pores of the surface of the porous substrate before the metal hydroxide layer is coated thereon to reduce the diameter of the pores of the surface and improve the distribution uniformity of the pores. Next, a metal hydroxide layer is coated on the porous substrate by the described method for fabricating the layered double hydroxide structure. The filled particles in the pores are included in the substrate by good adhesion between the metal hydroxide layer and the substrate, thereby increasing the adhesion between the filled particles and the substrate. Also, since the pores comprise the filled particles therein, it can prevent the metal hydroxide layer from permeating into the pores to cause an obstruction and reduce the gas flux of the porous substrate.

Then, the porous substrate with the metal hydroxide layer is calcined to transform the metal hydroxide layer into a continuous metal oxide layer, thereby forming a modified porous substrate. In an embodiment, the metal hydroxide layer is the layered double hydroxide described above and comprises the two different metals M_{A} and M_{B} described above. Based on the total weight of the metal hydroxide layer, in some embodiments, the weight content (wt %) of M_{B} is significantly higher than that of M_{A}, and M_{A} only exists in trace amounts, for example, M_{A} is present in an amount of only about 2.5-3.2 wt %. In alternative embodiments, M_{A} may be present in an amount of about 2.5-35 wt %. In some embodiments, M_{B} may be present in an amount of about 20-25 wt %, based on the total weight of the metal oxide layer, and M_{A} may be present in an amount of 0.5-30 wt %, based on the total weight of the metal oxide layer. In some embodiments, the calcination temperature may be about 300-1200° C., or 300-600° C., and the calcination time may be at least about 10 minutes, for example 10-60 minutes. Since the calcination temperature may have an effect on the phase formation in metal hydroxides layer, the calcination temperature may be adjusted to obtain particular phases. For example, in some embodiments where the metal oxide layer is an Al₂O₃ layer, if the calcination temperature is between 450-800° C., γ-Al₂O₃ may be obtained. In some embodiments, the metal oxide layer may have a thickness of about 0.1-3 μm. The thickness of the metal oxide layer is preferably controlled so that the modified porous substrate has a pore diameter of about 1-3 μm. Furthermore, compared with forming a layer of metal oxide particles on the porous substrate, forming a continuous metal oxide layer on the porous substrate may have anchoring effects. Thus, there is enhanced adhesion between the continuous metal oxide layer and the porous substrate, and the thickness of the metal oxide layer is more uniform.

After the metal hydroxide layer is calcined to be transformed into the metal oxide layer, a gas-selective layer may be optionally formed to form a gas separation module. The metal hydroxide layer is formed along the surface of the substrate when the metal hydroxide layer is coated on the porous substrate. Then, the metal hydroxide layer is calcined to be transformed into the metal oxide layer. In following processes, the gas-selective layer is formed along the surface of the metal oxide layer formed by deposition process. Since the continuous metal oxide layer is between the gas-selective layer and the porous substrate, the metal oxide layer may serve as an intermediate barrier layer to prevent the high temperature diffusion between the gas-selective layer and the porous substrate. The gas-selective layer may be formed by any suitable method such as an electroless plating, electroplating, sputtering, chemical vapor deposition, or plating method and so on. In addition, a suitable material for the layer may be chosen to separate specific gases. It is to be noted that, similarly, the material for the layer may have a CTE and/or lattice similar to that of the metal oxide layer so that there is enhanced structural stability between the layer and the metal oxide layer, such as enhanced adhesion and so on. In some embodiments, the gas-selective layer may be an inorganic layer comprising for example Pd, Pd—Ag alloys, Pd—Cu alloys, vanadium alloys, niobium alloys, or tantalum alloys. In some embodiments, a Pd layer may be used as the hydrogen-selective layer. The Pd layer may be formed and the gas separation module using the Pd layer may be operated according to the journal article by Chi et al. (Y. Chi, P. Yen, M. Jeng, S. Ko, and T. Lee, Int. J. Hydrogen Energy, 2010, 35, 6303-6310), which is herein incorporated in its entirety by reference. In this journal article, a 316 PSS coated with a metal oxide layer is activated sequentially by solutions each containing SnCl₂, de-ionized water, PdCl₂, and HCl, respectively, and subsequent to the activation electroless plating is carried out to form a Pd layer on the metal oxide layer. In some embodiments, the thickness of the gas-selective layer may be about 3-10 μm.

Some examples will be described below to describe the present disclosure more clearly and in more details. The inventive concept may be embodied in various forms without being limited to the exemplary embodiments set forth herein. Descriptions of well-known parts are omitted for clarity, and like reference numerals refer to like elements throughout.

### Example 1

A 316 stainless steel substrate (316PSS hereafter) was immersed in a basic solution containing Li⁺ and Al³⁺ for an hour and was dried subsequent to being immersed. The method for preparing the basic solution containing Li⁺ and Al³⁺ comprises the step of grinding about 0.1-0.4 g of the AlLi intermetallic compound into powder having a grain size of about 100-1000 μm in a ceramic mortar. In this example, Li was present in an amount of about 18-21 wt %, based on a total weight of the AlLi intermetallic compound. The AlLi intermetallic compound powder was then placed into 100 mL of pure water bubbling with an inert gas, such as Ar or N₂. Most of the AlLi intermetallic compound powder is dissolved by reacting with water after gas exposure and stirring processes are performed for several minutes. Thus, a clean basic solution containing Li⁺ and Al³⁺ was obtained by removing the impurities using a filter having a pore size of 5 A. In this example, the basic solution containing Li⁺ and Al³⁺ has a pH value around 11.0-12.3, a concentration of Li⁺ of about 200-600 ppm and a concentration of Al³⁺ of about 200-1100 ppm, as measured by an inductively coupled plasma-atomic emission spectrometry (ICP-AES). The above step of immersing and drying was repeated once to obtain a continuous aluminum hydroxide layer of sufficient thickness containing Li and having the layered double hydroxide (LDH) structure (hereafter Li—Al LDH) coated on the surface of 316PSS, forming the Li—Al LDH/316PSS. The thickness of Li—Al LDH layer was about 3 nm.

Then, the Li—Al LDH/316PSS was calcined for 2 hours at 450° C. for transforming the Li—Al LDH layer into an Al₂O₃ layer containing Li. In the present example, most of the Al₂O₃ layer had a γ phase, which is referred to as γ-Al₂O₃/316PSS hereafter.

Then, a Pd layer was formed on the Al₂O₃ layer, wherein the γ-Al₂O₃/316PSS was immersed successively in SnCl₂, de-ionized water, PdCl₂, 0.01 M HCl, and de-ionized water to activate γ-Al₂O₃/316PSS. The activated γ-Al₂O₃/316PSS was then placed in a Pd-ion-containing solution for electroless plating, forming a 316PSS sample with an Al₂O₃ layer and a Pd layer formed thereon, sequentially, and this sample will be referred to as Pd/γ-Al₂O₃/316PSS hereafter. The thickness of the Pd layer of Pd/γ-Al₂O₃/316PSS was about 11.5 μm.

Table 1 lists the experimental results of helium permeation flux and hydrogen permeance measurement at room temperature and 400° C., respectively. Compared with the helium permeation flux of 316PSS, the helium permeation flux of γ-Al₂O₃/316PSS was reduced to about half. After plating a Pd layer on γ-Al₂O₃/316PSS, a hydrogen permeance measurement for Pd/γ-Al₂O₃/316PSS was carried out at 400° C. for three times in total, and the hydrogen permeance was found to be about 52-54 Nm³/M²-hr-atm^{0.5}, and the H₂/He selectivity was found to be about 261-321.

TABLE 1

| | Helium permeation flux | |
|---|---|---|
| Sample (modified by the γ-Al₂O₃ layer) | (m³/m²-hr) | |
| 316PSS | 174.67 | |
| Li—Al LDH/316PSS | 0.2766 | |
| γ-Al₂O₃/316PSS | 78.86 | |
| Pd/γ-Al₂O₃/316PSS | 0.0089 | |
| Pd/γ-Al₂O₃/316PSS (Hydrogen permeance) | 52-54 | Nm³/m²-hr-atm^{0.5} |
| Pd/γ-Al₂O₃/316PSS (H₂/He selectivity) | 261-321 | |

The adhesion Pd layer to γ-Al₂O₃/316PSS was tested using the Crosshatch Test, ASTM D3359, wherein a matrix was first formed on the Pd layer by cutting into the layer, then a special tape was applied to the Pd layer with the matrix for 3 minutes, and lastly the special tape was pulled off in a direction obtained by rotating the direction in which the special tape was applied 180 degrees. The results showed that Pd layer peel-off was only found at sites that had been cut into by the knife, and the Pd layer still adhered to the γ-Al₂O₃ modifying layer in its integrity in areas other than these sites. Thus, there was enhanced adhesion between the γ-Al₂O₃ layer and the Pd layer fabricated according to the present disclosure, allowing for enhanced bonding between 316PSS and the Pd layer.

### Example 2

Al₂O₃ particles were filled into pores of the surface of the 316 PSS, wherein the average grain size of the Al₂O₃ particles was 10 μm. Next, the surface of the 316PSS is coated with a Li—Al LDH layer by repeating the method for fabricating the LDH structure as described in Example 1 for three times.

Then, the Li—Al LDH/Al₂O₃/316PSS was calcined by introducing N₂ in a furnace at a rate of temperature change of about 3° C./min. The crystallized water, carbonate ions and hydroxide ions of the Li—Al LDH layer were removed to transform the Li—Al LDH layer into an Al₂O₃ layer containing Li after the temperature reached and maintained 600° C. for 12 hours. In this example, most of the obtained Al₂O₃ layer had a γ phase, which is the sample referred to as γ-Al₂O₃/Al₂O₃/316PSS hereafter.

Then, a 316PSS sample having the Al₂O₃ particles in the pores thereof, and a γ-Al₂O₃ layer and a Pd layer formed thereon, sequentially, was formed by the electroless plating method as described in Example 1.

Tables 2 and 3 list the experimental results of a helium permeation flux measurement carried out at a helium permeation flux smaller than 0.01 m³/m²-hr, at room temperature with pressure difference of about 1 atm, for different condition comparison of the 316PSS coated with the Pd layer. A hydrogen permeance measurement is carried out at 400° C., and a H₂/He selectivity measurement is carried out at 400° C. with a pressure difference of about 4 atm.

TABLE 2

| | Helium permeation |
|---|---|
| Sample (modified by the γ-A1₂O₃ layer) | flux (m³/m²-hr) |
| 316PSS | 287.19 |
| Li—Al LDH/316PSS | 0.0239 |
| γ-Al₂O₃/316PSS | 116.23 |
| Pd/γ-Al₂O₃/316PSS | 0.0108 |
| Pd/γ-Al₂O₃/Al₂O₃/316PSS (thickness of the | 13.84 μm |
| Pd layer) | |
| Pd/γ-Al₂O₃/316PSS(Hydrogen permeance) | 64.58 Nm³/m²-hr-atm^{0.5} |
| Pd/γ-Al₂O₃/316PSS(H₂/He selectivity) | 230 |

TABLE 3

| Sample (modified by the Al₂O₃ particles and | Helium permeation flux | |
|---|---|---|
| the γ-Al₂O₃ layer) | (m³/m²-hr) | |
| Al₂O₃/316PSS | 290.01 | |
| Li—Al LDH/Al₂O₃/316PSS | 0.0525 | |
| γ-Al₂O₃/Al₂O₃/316PSS | 123.91 | |
| Pd/γ-Al₂O₃/Al₂O₃/316PSS | 0.0136 | |
| Pd/γ-Al₂O₃/Al₂O₃/Al₂O₃/316PSS (thickness | 9.16 | μm |
| of the Pd layer) | | |
| Pd/γ-Al₂O₃/Al₂O₃/316PSS (Hydrogen | 82.30 | Nm³/m²-hr-atm^{0.5} |
| permeance) | | |
| Pd/γ-Al₂O₃/Al₂O₃/316PSS (H₂/He | 407 | |
| selectivity) | | |

The experimental results show that the helium permeation flux of the 316PSS modified by the Li—Al LDH layer was reduced from 287.19 to 0.0239 Nm³/m²-hr. However, the helium permeance flux increased from 0.0239 to 116.23 Nm³/m²-hr after removing the crystallized water, carbonate ions and hydroxide ions of the LDH layer calcined at 600° C. Then, the Pd layer was formed on the 316PSS by performing the electroless plating method until the helium permeation flux was smaller than 0.01 Nm³/m²-hr and the thickness of the Pd layer was about 13.84 μm measured by a gravimetric method. The 316PSS coated with the Pd layer was further placed under a hydrogen containing ambient environment with a high temperature, such as 400° C., and the helium permeation flux thereof was measured at different pressure differences, such as 1-4 atm. A slope (i.e., the hydrogen permeance) of about 64.58 Nm³/M²-hr-atm^{0.5} and an H₂/He selectivity of 230 is obtained by plotting a function graph of the pressure difference taken at the 0.5^{th} order and the helium permeation flux.

On the other hand, in the condition of the same densification of the Pd layer, the desired thickness of the Pd layer for the 316PSS having the Al₂O₃ particles with the average grain size of 10 μm filled therein and modified by one γ-Al₂O₃ layer, was thinner, such that the desired amount of Pd was reduced by about 33.8%. Moreover, due to the thickness reduction of the Pd layer, the hydrogen permeance was increased by about 27% (e.g. from 64.58 to 82.30 Nm³/m²-hr-atm^{0.5}) and the H₂/He selectivity was increased by about 77% (e.g. from 230 to 407). Accordingly, compared to the 316PSS modified by directly coating the γ-Al₂O₃ layer on the 316PSS, the 316PSS modified by filling the Al₂O₃ particles having the average grain size of 10 μm into the pores of the surface of the 316PSS before the γ-Al₂O₃ layer is coated on the 316PSS, improves the hydrogen permeance and the H₂/He selectivity of the Pd layer and reduces the required thickness of the Pd layer.

Thus, the modifying layer fabricated by the method for modifying the porous substrate of the present disclosure provided enhanced adhesion to the porous substrate. Furthermore, a gas-selective layer may be formed on the modifying layer, and the combination of the porous substrate, the modifying layer, and the layer, may be used as a gas separation module to be applied in the separation of specific gases. Furthermore, the adhesion of the Pd layer to the modifying layer was enhanced. Therefore, enhanced bonding between the porous substrate and the gas-selective layer may be achieved by using the modifying layer of the present disclosure. Furthermore, the required thickness of the layer can be reduced by filling the particles into the pores of the porous substrate before forming the modifying layer to obtain a smooth surface. The adhesion between the filled particles and the porous substrate can be enhanced by the modifying layer, thereby preventing decreasing the lifespan, and decreasing poor hydrogen purification due to poor adhesion. Besides, it does not matter whether the modifying layers are directly formed on the porous substrate or formed thereon after filling of the particles, the resulting modifying layers are relatively less dense. When the gas-selective layer is plated, the gas-selective layer may permeate into the modifying layers so as to increase the channels for hydrogen permeation. Therefore, higher hydrogen permeance results when performing hydrogen permeation experiments carried out at high temperatures.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A method for modifying a porous substrate, comprising:
coating at least a metal hydroxide layer on a porous substrate; and
calcining the porous substrate having the metal hydroxide layer to transform the metal hydroxide layer into a continuous metal oxide layer, forming a modified porous substrate.

2. The method for modifying a porous substrate as claimed in claim 1, wherein the porous substrate comprises porous stainless steels or porous nickel-based alloys.

3. The method for modifying a porous substrate as claimed in claim 1, wherein the metal hydroxide layer is a layered double hydroxide, and a process for coating the metal hydroxide layer comprises a step of placing the porous substrate in a basic solution, wherein the basic solution comprises ions of a first metal and ions of a second metal different from the first metal.

4. The method for modifying a porous substrate as claimed in claim 3, wherein the ions of the first metal comprise Al³⁺, Mn³⁺, Ni³⁺, Fe³⁺, or Cr³⁺, and the ions of the second metal comprise Ni²⁺, Mg²⁺, Zn²⁺, Ca²⁺, Cu²⁺, Mn²⁺, Li⁺, Na⁺, or K⁺.

5. The method for modifying a porous substrate as claimed in claim 3, wherein a pH value of the basic solution is 11.0-12.3.

6. The method for modifying a porous substrate as claimed in claim 3, wherein the basic solution has an ion concentration of the first metal of about 200-1100 ppm and an ion concentration of the second metal of about 200-600 ppm.

7. The method for modifying a porous substrate as claimed in claim 3, wherein the second metal is present in an amount of about 0.5-30 wt %, based on a total weight of the metal oxide layer.

8. The method for modifying a porous substrate as claimed in claim 1, wherein the calcination temperature is about 300-600° C.

9. The method for modifying a porous substrate as claimed in claim 1, wherein the metal oxide layer has a thickness of about 0.1-3 μm.

10. The method for modifying a porous substrate as claimed in claim 1, further comprising forming a gas-selective layer on the metal oxide layer, thereby forming a gas separation module.

11. The method for modifying a porous substrate as claimed in claim 10, wherein the gas-selective layer comprises Pd, Pd—Ag alloys, Pd—Cu alloys, vanadium alloys, niobium alloys, or tantalum alloys.

12. The method for modifying a porous substrate as claimed in claim 1, further comprising filling a plurality of particles into pores of the porous substrate before coating the metal hydroxide layer on the porous substrate.

13. The method for modifying a porous substrate as claimed in claim 12, wherein the plurality of particles comprises aluminum oxide, silicon oxide, calcium oxide, cerium oxide, titanium oxide, chromium oxide, manganese oxide, iron oxide, nickel oxide, copper oxide, zinc oxide or zirconium oxide, and has a grain size of about 1-30 μm.

14. A modified porous substrate, comprising:
a porous substrate; and
a continuous metal oxide layer, coated on the porous substrate, wherein the continuous metal oxide layer contains a first metal oxide and a second metal that is different from the first metal.

15. The modified porous substrate as claimed in claim 14, wherein the porous substrate comprises porous stainless steels or porous nickel-based alloys.

16. The modified porous substrate as claimed in claim 15, wherein the first metal oxide comprises aluminum oxide, chromium oxide, iron oxide, nickel oxide, manganese oxide, or combinations thereof.

17. The modified porous substrate as claimed in claim 14, wherein the metal oxide layer has a thickness of about 0.1-3 μm.

18. The modified porous substrate as claimed in claim 14, wherein the second metal comprise Ni, Mg, Zn, Ca, Cu, Mn, Li, Na, or K.

19. The modified porous substrate as claimed in claim 18, wherein the second metal is present in an amount of about 0.5-30 wt %, based on a total weight of the metal oxide layer.

20. The modified porous substrate as claimed in claim 14, further comprising forming a gas-selective layer on the metal oxide layer, thereby forming a gas separation module.

21. The modified porous substrate as claimed in claim 14, wherein the gas-selective layer comprises Pd, Pd—Ag alloys, Pd—Cu alloys, vanadium alloys, niobium alloys, or tantalum alloys.

22. The modified porous substrate as claimed in claim 14, further comprising filling a plurality of particles into pores of the porous substrate.

23. The modified porous substrate as claimed in claim 22, wherein the plurality of particles has a grain size of about 1-30 μm.
